(19) United States
(12) Patent Application Publication
(10) Pub. No.: US 2010/0116110 A1
(43) Pub. Date: May 13, 2010

(54) SHEET PROCESSING APPARATUS AND SHEET PROCESSING METHOD

(75) Inventor: Hiroyuki Tsuchihashi, Mishima (JP)

Correspondence Address: TUROCY & WATSON, LLP, 127 Public Square, 57th Floor, Key Tower, CLEVELAND, OH, 44114, US

(73) Assignee: TOSHIBA TEC KABUSHIKI KAISHA, Tokyo (JP)

(21) Appl. No.: 12/690,361

(22) Filed: Jan. 20, 2010

Related U.S. Application Data
(62) Division of application No. 11/533,947, filed on Sep. 21, 2006.

(30) Foreign Application Priority Data
Sep. 22, 2005 (JP) 2005-276592
Sep. 22, 2005 (JP) 2005-276593

(51) Int. Cl. B26D 5/20; B26D 7/27; B65H 9/00

(52) U.S. Cl. 83/73; 83/74; 83/367; 83/370; 83/436.3; 83/669

(57) ABSTRACT

A sheet processing apparatus comprises a first conveyer roller pair and a second conveyer roller pair arranged sequentially from the upstream side to the downstream side along a sheet conveyance route of a sheet of paper along with a punching unit disposed between the first and second conveyer roller pairs. The punching unit includes a hole cutting blade that is capable of retractably projecting the hole cutting blade relative to the sheet conveyance route so as to control the position of the hole cutting blade of the punching unit according to the condition of the sheet of paper being conveyed. The apparatus further comprises a control unit adapted to cause the hole cutting blade to project across the sheet conveyance route before the leading end of the sheet of paper being conveyed gets to the punching unit so as to make the leading end of the sheet of paper abut the hole cutting blade and correct the skew, if any, of the sheet of paper.

### CROSS-REFERENCE TO RELATED APPLICATIONS

This application is a Division of co-pending U.S. patent application Ser. No. 11/533,947 filed on Sep. 21, 2006, which is based upon and claims the benefit of priority from the prior Japanese Patent Application No. 2005-276592 filed on Sep. 22, 2005 and Japanese Patent Application No. 2005-276593 filed on Sep. 22, 2005, the entire contents of all of which are incorporated herein by reference.

### BACKGROUND OF THE INVENTION

1. Field of the Invention

The present invention relates to a sheet processing apparatus for correcting skews and performing punching processes on the sheets delivered from an image forming apparatus

2. Description of the Related Art

Image forming apparatus including MFPs (multi function peripherals), copying machines and printers are provided at the sheet delivery section of the image forming apparatus main body with a post-processing unit for performing post-processing operations including an operation of sorting sheets where an image is formed, that of stapling sheets and/or that of punching sheets.

In such a post-processing unit, the sheet of paper delivered from the image forming apparatus can move aslant and become skewed relative to the sheet delivering direction. When the skewed sheet of paper is subjected to a punching process (and punched), one or more than one holes can be produced at wrong positions by the punching process to give rise to a problem for a succeeding filing operation. For this reason, the post-processing unit is equipped with a skew correcting means for correcting the skew (if any) of the sheet of paper before the punching process.

Jpn. Pat. Appln. Laid-Open Publication No. 2002-274699 describes a sheet processing apparatus. The apparatus described in the above-cited Patent Document comprises a punch unit for performing a punching process on the sheet of paper being delivered to it on which an image has already been formed and the sheet of paper is made to abut the nipper of the inlet roller arranged upstream relative to the punch unit in order to correct the skew, if any, of the sheet of paper. However, with the apparatus described in the above-cited Patent Document, the sheet of paper to be corrected for the skew, if any, can be pinched by the nipper of the inlet roller to prevent the skew, if any, from being corrected.

Jpn. Pat. Appln. Laid-Open Publication No. 2002-193493 describes a punching processing apparatus. In the punching processing apparatus described in the above-cited Patent Document, a registration roller is arranged downstream relative to the punching means of the apparatus and the front end of the sheet of paper is made to abut the registration roller by the sheet conveying force of the sheet delivering roller of the image forming apparatus main body to correct the skew, if any. However, since the sheet conveying fore of the sheet delivering roller of the image forming apparatus main body is utilized, the positional relationship between the image forming apparatus main body and the post-processing apparatus need to be precisely defined so that the mechanical configuration of the post-processing apparatus is disadvantageously subjected to limitations.

Jpn. Pat. Appln. Laid-Open Publication No. 2002-302332 describes an image forming apparatus having a punch device. In the image forming apparatus described in the above-cited Patent Document, a stop member is made to project across the sheet conveyance route and one or more than one holes are cut in the sheet of paper stopped by the stop member by means of the punch. However, the above-cited Patent Document does not describe anything about skew correction.

Jpn. Pat. Appln. Laid-Open Publication No. 2004-217337 described a post-processing apparatus having an alignment means for aligning a sheet of paper. In the post-processing apparatus described in the above-cited Patent Document, the skew, if any, of the sheet of paper is corrected by the alignment means and then forced to abut an abutment member before it is subjected to a punching process. However, the post-processing apparatus requires an alignment plate and other parts to make the structure of the apparatus a complicated one.

In view of the above-identified circumstances, it is therefore the object of the present invention to provide a sheet processing apparatus having a simple configuration that can correct the skew, if any, of a sheet of paper and accurately execute a punching process.

### BRIEF DESCRIPTION OF THE DRAWINGS

FIG. 1 is a schematic illustration of an image forming apparatus equipped with a sheet processing apparatus according to the present invention, showing the overall configuration thereof;

FIG. 2 is a schematic illustration of an embodiment of the sheet processing apparatus according to the present invention, showing the configuration thereof;

FIG. 3 is a schematic block diagram of the control system of the sheet processing apparatus according to the present invention;

FIGS. 4A through 4E are schematic illustrations of the operation of the sheet processing apparatus of FIG. 2;

FIGS. 5A and 5B are schematic plan views of the sheet processing apparatus of FIG. 2, illustrating the skew correcting operation thereof;

FIG. 6 is a schematic illustration of the second embodiment of the sheet processing apparatus according to the present invention, showing the configuration thereof;

FIG. 7 is a schematic perspective view of the punch unit to be used in the sheet processing apparatus of FIG. 6, illustrating the specific configuration thereof;

FIGS. 8A and 8B are schematic perspective views of the punch unit of FIG. 7, illustrating the skew correcting operation thereof;

FIGS. 9A through 9E are schematic illustrations of the operation of the sheet processing apparatus of FIG. 6;

FIGS. 10A and 10B are schematic plan views of the sheet processing apparatus of FIG. 6, illustrating the skew correcting operation thereof; and

FIG. 11 is a schematic illustration of an image forming apparatus provided with another embodiment of the sheet processing apparatus according to the present invention, showing the overall configuration thereof.

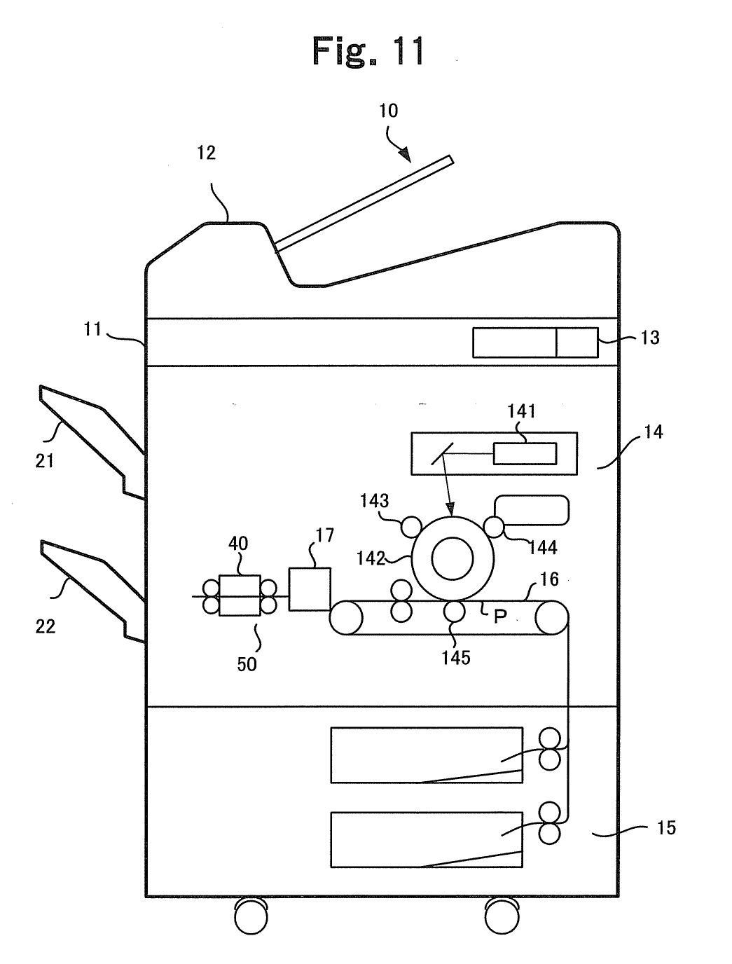

### DETAILED DESCRIPTION OF THE INVENTION

Throughout this description, the embodiments and examples shown should be considered as exemplars, rather than limitations on the apparatus of the present invention.

Now, the present invention will be described by referring to the accompanying drawings that illustrate preferred embodiments of the invention. Throughout the drawings, the same or similar components are denoted respectively by the same reference symbols.

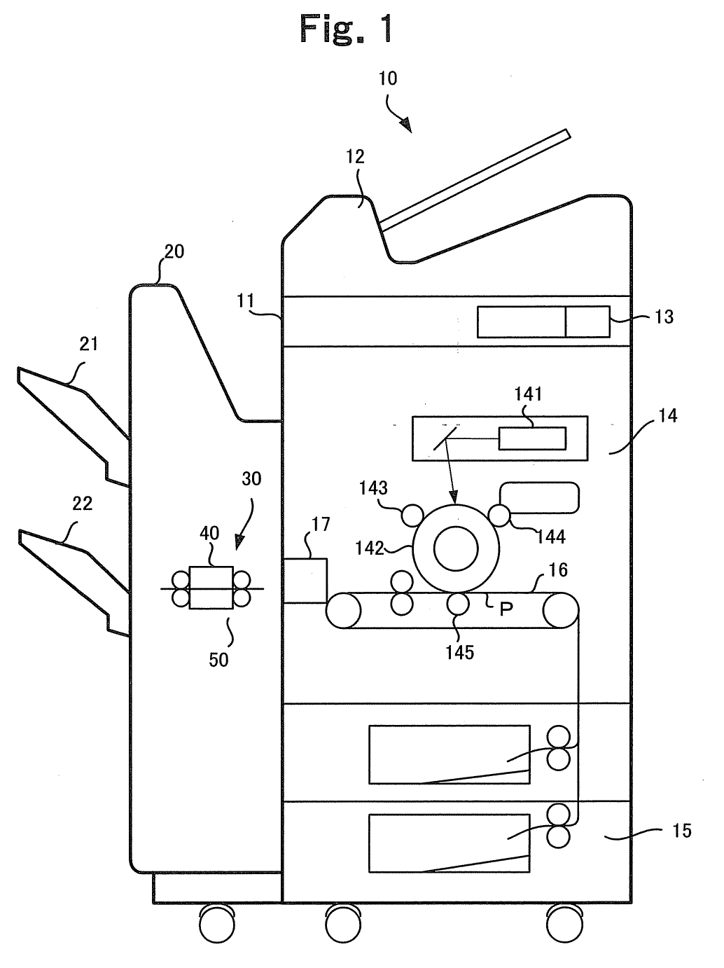

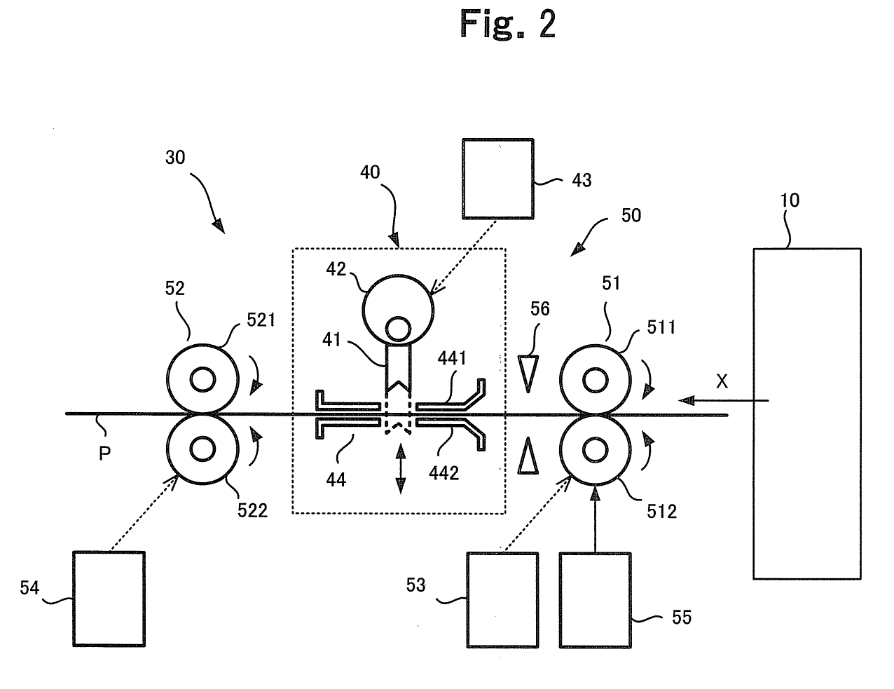

FIG. 1 is a schematic illustration of an image forming apparatus equipped with a sheet processing apparatus according to the present invention, showing the overall configuration thereof. FIG. 2 is a schematic illustration of a principal part of an embodiment of the sheet processing apparatus according to the present invention, showing the configuration thereof.

FIG. 1 shows an MFP (multi function peripheral) that operates as an image forming apparatus. The image forming apparatus 10 comprises a scanner section 11, an automatic document feeder (ADF) 12 and an operation section 13 in an upper part thereof. A printer section 14 and a sheet feeding section 15 are arranged respectively in a central part and in a lower part of the image forming apparatus 10. A finisher 20 is arranged contiguously relative to the image forming apparatus 10 for punching operations and stapling operations.

The printer section 14 typically has a tandem type color laser printer. The printer section 14 includes a laser 141 and a photosensitive drum 142. A charging device 143, a developing device 144 and a transferring device 145 are arranged around the photosensitive drum 142. Toner is supplied to the developing device 144 from a toner cartridge.

Now, the operation of the printer section 14 will be summarily described below. The surface of the photosensitive drum 142 is scanned for exposure by the laser beam from the laser 141 to form an electrostatic latent image on the photosensitive drum 142. The electrostatic latent image is developed by the developing device 144 to form a toner image on the photosensitive drum 142. The toner image is then transferred onto a sheet of paper P by the transferring device 145. For a color printing process, toner cartridges of four colors including cyan, magenta, yellow and black are arranged in a row and photosensitive drums and optical units of the respective colors are provided.

The sheet feeding section 15 has a plurality of sheet feeding cassettes for containing sheets of paper of various different sizes. A sheet of paper P is sent from one of the sheet feeding cassettes to conveyor belt 16 and an image is formed on the sheet of paper P. The sheet of paper P on which an image is formed is then delivered and conveyed to the finisher 20 by way of sheet delivery section 17.

The finisher 20 performs post-processing operations such as stapling and punching on the sheet of paper P and delivers it to either a sheet delivery tray 21 or a sheet delivery tray 22. The sheet delivery trays 21, 22 are driven to move up and down by a sheet delivery tray drive section so that the sheet of paper P is delivered to either of the trays.

The finisher 20 is provided with a sheet processing apparatus 30 according to the present invention. The sheet processing apparatus 30 comprises a punching unit 40 for punching the sheet of paper P conveyed from the image forming apparatus 10 and a skew correcting section 50 for correcting the skew, if any, of the sheet of paper P before punching the sheet.

FIG. 2 schematically illustrates the specific configuration of the sheet processing apparatus 30. Referring to FIG. 2, reference symbol 40 denotes the punching unit. The punching unit 40 includes a hole cutting blade 41, an eccentric cam 42 for driving the hole cutting blade 41 to move up and down, a punch motor 43 for driving the eccentric cam 42 to rotate and a punch die 44.

The hole cutting blade 41 is constantly urged in the direction of the eccentric cam 42. The punch die 44 includes an upper die 441 and a lower die 442 and the sheet of paper P is conveyed between the upper die 441 and the lower die 442. The sheet of paper P is punched as the hole cutting blade 41 is reciprocated in the direction of the punch die 44 (that is orthogonal relative to the direction of conveying the sheet of paper P). While the eccentric cam 42 is described above as means for reciprocating the hole cutting blade 41, it may be replaced by some other means for reciprocating the hole cutting blade 41.

On the other hand, a first conveyer roller pair 51 and a second conveyer roller pair 52 are arranged respectively at the sheet feeding side and at the sheet discharging side of the punching unit 40 to convey the sheet of paper along a conveyance route. The conveyer roller pairs 51, 52 are driven to rotate respectively by conveyor motors 53, 54.

The first conveyer roller pair 51 includes upper and lower conveyer rollers 511, 512, which are driven to rotate by the conveyer motor 53 to convey a sheet of paper P, pinching it between them. Similarly, the second conveyer roller pair 52 includes upper and lower conveyer rollers 521, 522, which are driven to rotate by the conveyer motor 54 to convey a sheet of paper P, pinching it between them.

The first conveyer roller pair 51 can change the condition of contact of the rollers 511, 512 by means of a load controller 55. More specifically, the first conveyer roller pair 51 has a functional feature of registration roller where the rollers 511, 512 are brought into tight contact with each other and a functional feature of slipping roller where the rollers 521, 522 are brought into loose contact with each other. It operates as registration roller when conveying a sheet of paper, whereas it operates as slipping roller when correcting the skew, if any, of the sheet of paper.

A sensor 56 is arranged between the sheet feeding side of the punching unit 40 and the first conveyer roller pair 51 to detect the condition of the sheet of paper P being fed in and conveyed. In this embodiment of the invention, the sheet of paper P is turned upside down (with the image carrying surface facing downward) when it is conveyed in the direction of arrow X. Any of a variety of mechanisms for turning the sheet of paper P upside down may be used for the purpose of the present invention.

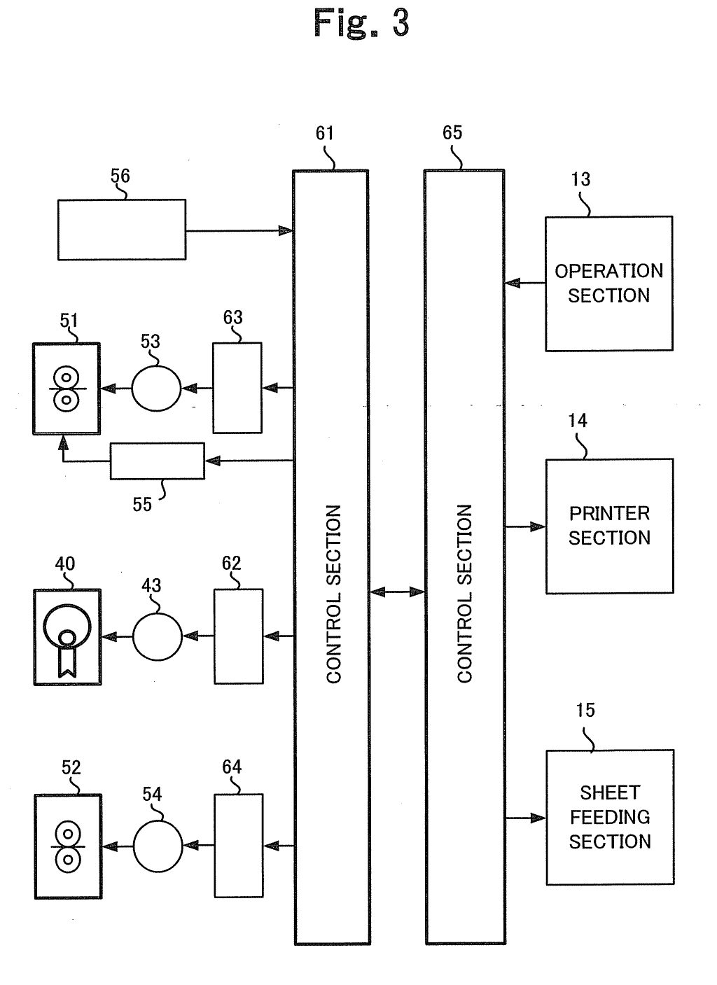

FIG. 3 is a schematic block diagram of the control system of a sheet processing apparatus 30 according to the present invention and an image forming apparatus 10 to be used with the sheet processing apparatus 30. Referring to FIG. 3, reference symbol 61 denotes a control section, which is a microprocessor that includes a CPU. In FIG. 3, reference symbol 62 denotes a motor drive circuit for driving the punching motor 43 and reference symbol 63 denotes a motor drive circuit for driving the conveyer motor 53, whereas reference symbol 64 denotes a motor drive circuit for driving the conveyer motor 54. The control section 61 controls the load controller 55 and the outcome of the detecting operation of the sensor 56 is input to it.

In FIG. 3, reference symbol 65 denotes a control section for controlling the image forming apparatus 10, which is a microprocessor that includes a CPU. The control section 61 and the control section 65 exchange information with each other to coordinate the image forming operation of the image forming apparatus 10 and the operation of the finisher 20. Various directives are input by the user to the control section 65 by way of the operation section 13 and the control section 65 controls the operation of the printer section 14 and that of the sheet feeding section 15 according to the directives so as to convey the sheet of paper P on which an image is formed to the finisher 20.

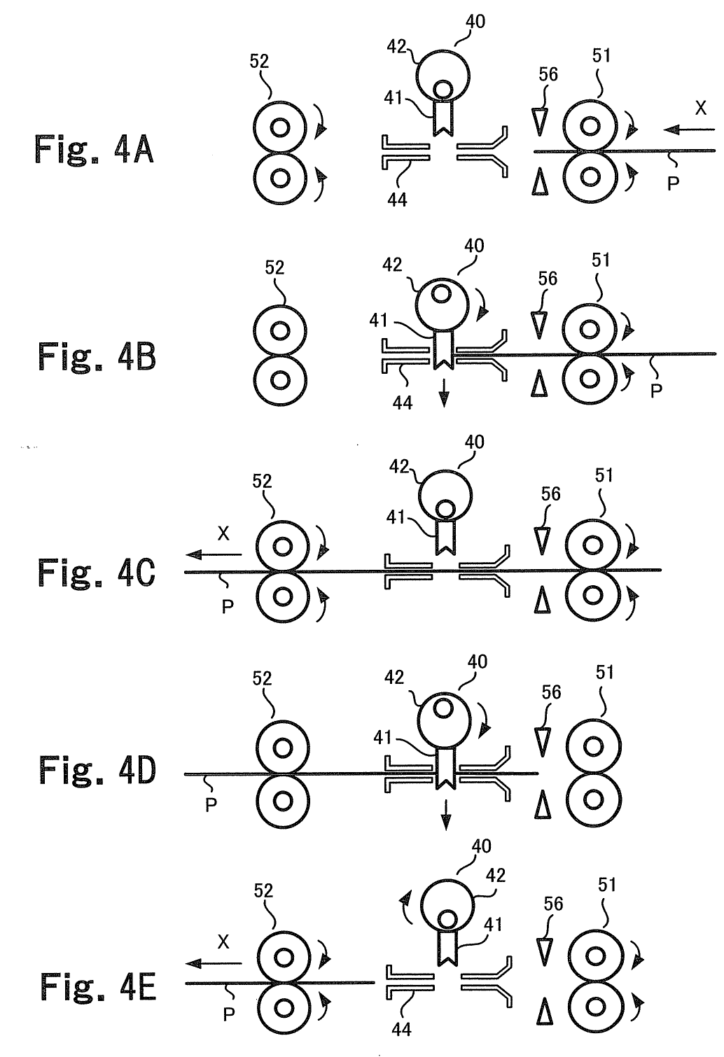

Now, the operation of the sheet processing apparatus 30 according to the present invention will be described by referring to FIGS. 4A through 4E. The sheet of paper P on which an image is formed by the printer section 14 of the image forming apparatus 10 is then conveyed to the sheet processing apparatus 30. Since the sheet of paper P flows from the printer section 14 toward the tray 21 or the tray 22, the side of the printer 14 is referred to as upstream side and the side of the tray 21 or the tray 22 is referred to as downstream side in the following description.

FIG. 4A illustrates a condition where the sheet of paper P on which an image is formed by the printer section 14 is being conveyed toward the punching unit 40. In the initial stages, the first conveyer roller pair 51 and the second conveyer roller pair 52 are driven respectively by the conveyer motors 53, 54 and the sheet of paper P is conveyed in the first direction (as indicated by arrow X) from the upstream side toward the downstream side. The hole cutting blade 41 of the punching unit 40 is separated from and located above the punching die 44 in this condition.

As the sheet of paper P is conveyed and sensor 56 detects that the leading end of the sheet of paper P passes the first conveyer roller pair 51, the punching motor 43 starts rotating to drive the eccentric cam 42 to rotate and lower the hole cutting blade 41 in the direction toward the punching die 44. As a result, the hole cutting blade 41 projects to block the sheet conveyance route. In other words, the hole cutting blade 41 operates as a stopper member that retractably projects across the sheet conveyance route so that it can temporarily stop the sheet of paper P being conveyed.

The first conveyer roller pair 51 is controlled by the load controller 55 in such a way that the rollers 511, 512 thereof lightly contact with each other and operate as slipper roller. Then, as a result, the first conveyer roller pair 51 conveys the sheet of paper P downstream with force weaker than before and makes the sheet of paper P abut the projecting hole cutting blade 41.

Thus, the rollers 511, 512 of the first conveyer roller pair 51 lightly touch the sheet of paper P and push it against the hole cutting blade 41 so that, if the sheet of paper P is skewed, the skew is corrected.

Then, as shown in FIG. 4C, the eccentric cam 42 of the punching unit 40 is driven to rotate by the punching motor 43 with the sheet of paper P corrected for the skew, if any, and the hole cutting blade 41 is lifted to move away from the sheet conveyance route. Subsequently, the first conveyer roller pair 51 is controlled by the load controller 55 so as to operate as registration roller and driven to rotate by the motor 53 and convey the sheet of paper P that is corrected for the skew, if any, in the direction of arrow X.

As the sheet of paper P is conveyed by a predetermined distance and the sensor 56 detects that the tail end of the sheet of paper P passes the first conveyer roller pair 51 as viewed in the sheet conveying direction, the conveyer motor 54 stops rotating and hence the second conveyer roller pair 52 also stops rotating as shown in FIG. 4D. Then, the eccentric cam 42 of the punching unit 40 is driven to rotate by the punching motor 43 and the hole cutting blade 41 once again projects across the sheet conveyance route and executes a punching process on the sheet of paper P.

As the punching process is completed, the eccentric cam 42 is driven to rotate by the punching motor 43 in a manner as shown in FIG. 4E to raise the hole cutting blade 41. Then, the first and second conveyer roller pairs 51, 52 are driven to rotate respectively by the conveyer motors 53, 54 and the sheet of paper P is conveyed away. Thereafter, the steps of operation of FIGS. 4A through 4E are repeated so that sheets of paper P are sequentially subjected to a punching process and then delivered to the delivery tray 21 or 22.

The sensor 56 detects the leading end of the sheet of paper P when the sheet of paper P is fed in by way of the first conveyer roller pair 51. It also detects that the tail end of the sheet of paper P passes the position vis-à-vis the sensor 56, and notifies the control section 61 of what it detects. Then, the control section 61 controls the motor drive circuits 62, 63, 64 and the load controller 55 according to what is detected by the sensor 56.

Note that, as for the timing of lowering the hole cutting blade 41, it may be so arranged that the punching motor 43 is driven to rotate after the elapse of a predetermined time period since the time when the sensor 56 detects a sheet of paper P being fed in. Alternatively, it may be so arranged that a stepping motor is used as the punching motor 43 and a predetermined number of pulses are supplied to the stepping motor from the time when a sheet of paper P being fed in is detected by the sensor 56 to control the rotary angle of the punching motor 43.

As for the timing of restarting the conveyer roller 52 after stopping it, it may be so arranged that the conveyer motor 56 is driven to rotate after the elapse of a predetermined time period since the time when the sensor 56 detects a sheet of paper P being fed in. Alternatively, it may be so arranged that the conveyer motor 54 is driven to rotate when the rise of the hole cutting blade 41 is detected.

While the motor drive circuit 62, 63, 64 are controlled according to the outcome of detection of the sensor 56 in the above description, it may be alternatively be so arranged that they are controlled according to the information received from the image forming apparatus 10. For example, the delivery of a sheet of paper P may be detected by way of the delivery section 17 of the image forming apparatus 10 and the elapse of a predetermined time period may be gauged by referring to the time of detection to drive the motor drive circuit 62, 63, 64.

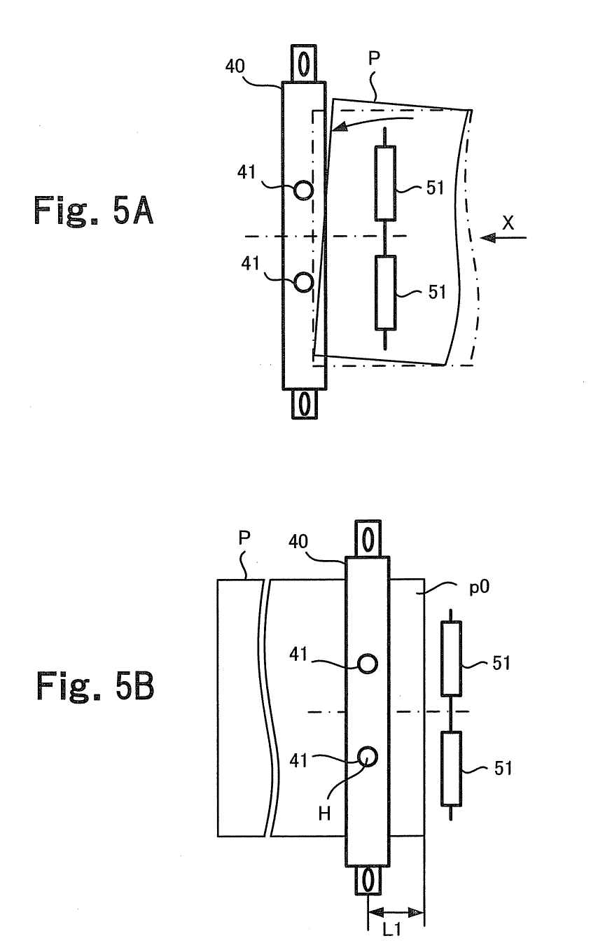

FIGS. 5A and 5B are schematic plan views of the sheet processing apparatus of FIG. 2, illustrating the skew correcting process and the punching process thereof. FIG. 5A shows the condition of the sheet processing apparatus when a sheet of paper P passes the first conveyer roller pair 51 and abuts the hole cutting blade 41. This condition corresponds to that of FIG. 4B. If the sheet of paper P is skewed as indicated by solid lines in FIG. 5A, the skew is corrected as indicated by dotted chain line in FIG. 5A because the first conveyer roller pair 51 operates as slipping roller at this time and the sheet of paper is continuously and lightly pushed by the rotary motion of the first conveyer roller pair 51.

After the skew is corrected, the sheet of paper P is conveyed in the X direction by the first conveyer roller pair 51 and the second conveyer roller pair 52. When the tail end p0 of the sheet of paper P passes the first conveyer roller pair 51, the sensor 56 detects it and the operation of conveying the sheet of paper P is stopped and the sheet of paper P is subjected to a punching process by the punching unit 40 as shown in FIG. 5B. This condition corresponds to that of FIG. 4D. As a result, the sheet of paper P is punched at the right position and conveyed away.

The hole cutting position of the punching process is defined typically by the predetermined distance L1 from the tail end p0 of the sheet of paper P as viewed in the sheet conveying direction (e.g., 12 mm). If the gap between the tail end p0 and the hole cutting position of the sheet of paper P is L1, the control section 61 performs its control operation in such a way that the conveyance of the sheet of paper is temporarily stopped at a position where the gap between the hole cutting blade 41 and the tail end p0 of the sheet of paper becomes equal to L1 to carry out a hole cutting operation before the tail end p0 of the sheet of paper passes the punching unit.

In this way, with the sheet processing apparatus 30 according to the present invention, a sheet of paper P is conveyed from the upstream side to the downstream side and the first conveyer roller pair 51 is made to operate as slipping roller when the sheet of paper P is fed in so that the leading end of the sheet of paper P is made to abut the hole cutting blade 41 of the punching unit 40 in order to correct the skew, if any, of the sheet of paper.

Additionally, the hole cutting blade 41 of the punching unit 40 is utilized as stopper member that can retractably project across the sheet conveyance route. In other words, the number of components is minimized because the hole cutting blade 41 of the punching unit 40 operates both in the skew correction mode and the hole cutting mode of operation. Still additionally, this invention provides ease of designing the finisher 20 and can simplify the configuration thereof because the first and second conveyer roller pairs can be arranged totally in the inside of the finisher 20. Thus, with a sheet processing apparatus according to the present invention, it is possible to correct the skew, if any, of the sheet of paper being processed and accurately execute a punching process.

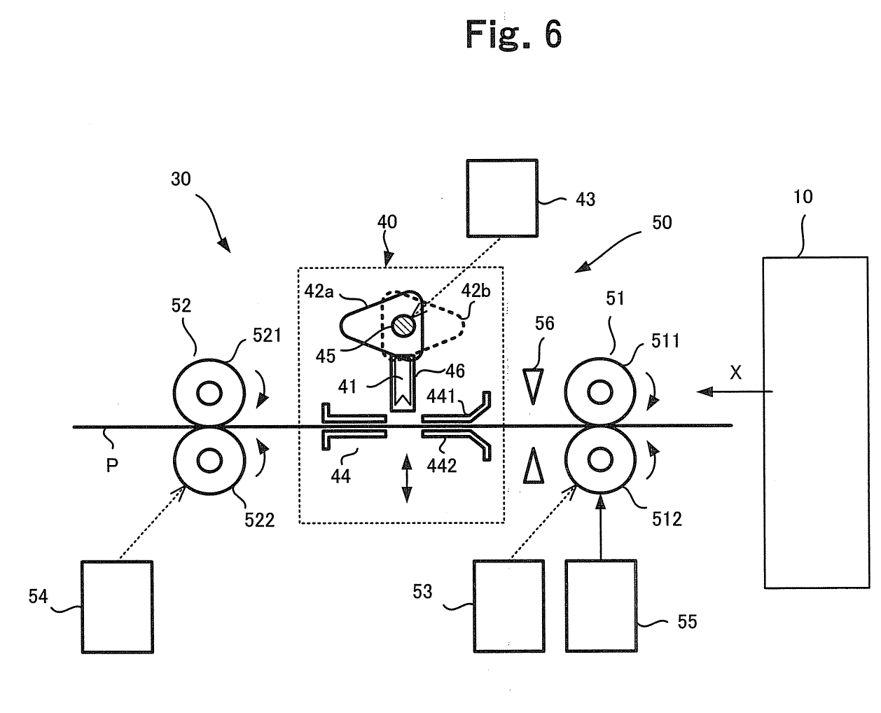

Now, the second embodiment of the sheet processing apparatus 30 according to the present invention will be described by referring to FIG. 6.

FIG. 6 is a schematic illustration of the second embodiment of the sheet processing apparatus 30 according to the present invention, showing the principal configuration thereof.

Referring to FIG. 6, reference symbol 40 denotes a punching unit. The punching unit 40 includes a rotary shaft 45, eccentric cams 42a, 42b fitted to the rotary shaft 45, a hole cutting blade 41 driven to move up and down by the rotary motion of the eccentric cam 42a, a shutter 46 driven to move up and down by the rotary motion of the eccentric cam 42b, a punching die 44 and a motor 43 for driving the rotary shaft 45 to rotate.

The eccentric cams 42a, 42b are fitted to the rotary shaft 45 and separated from each other by a predetermined gap. The eccentric cams 42a, 42b are arranged in such a way that their front ends are angularly separated from each other by an angle of 180°. The eccentric cams 42a, 42b are adapted to rotate and operate in a symmetric manner. The hole cutting blade 41 and the shutter 46 are arranged so as to be respectively held in contact with the eccentric cams 42a, 42b and the hole cutting blade 41 is driven to move up and down by the rotary motion of the eccentric cam 42a, whereas the shutter 46 is driven to move up and down by the rotary motion of the eccentric cam 42b. Thus, the hole cutting blade 41 and the shutter 46 projects and retreat relative to the sheet conveyance route in a manner inverted relative to each other.

In this embodiment, the shutter 46 operates as stopper member that can retractably project across the sheet conveyance route.

The punching die 44 includes an upper die 441 and a lower die 442 and a sheet of paper P is conveyed between the upper and lower dies. Both a punching operation and a skew correcting operation are performed as the hole cutting blade 41 and the shutter 46 are driven to reciprocate in the direction of the punching die 44 (that is orthogonal relative to the direction of conveying the sheet of paper P), the operations will be described in greater detail hereinafter.

On the other hand, first and second conveyer roller pairs 51, 52 are arranged respectively at the sheet feeding side and the sheet discharging side of the punching unit 40 to convey the sheet of paper from the upstream side to the downstream side. The conveyer roller pairs 51, 52 are driven to rotate respectively by conveyer motors 53, 54.

The first conveyer roller pair 51 includes upper and lower conveyer rollers 511, 512, which are driven to rotate by the conveyer motor 53 to convey a sheet of paper P, pinching it between them. Similarly, the second conveyer roller pair 52 includes upper and lower conveyer rollers 521, 522, which are driven to rotate by the conveyer motor 54 to convey a sheet of paper P, pinching it between them.

The first conveyer roller pair 51 can change the condition of contact of the rollers 511, 512 by means of a load controller 55. More specifically, the first conveyer roller pair 51 has a functional feature of registration roller where the rollers 511, 512 are brought into tight contact with each other and a functional feature of slipping roller where the rollers 511, 512 are brought into loose contact with each other. The pair of rollers 511, 512 operate as registration roller when conveying a sheet of paper, whereas they operate as slipping roller when correcting the skew, if any, of the sheet of paper (as will be described in greater detail hereinafter). A sensor 56 is arranged between the sheet feeding side of the punching unit 40 and the first conveyer roller pair 51 to detect the condition of the sheet of paper P being fed in and conveyed.

The control system of the sheet processing apparatus 30 of FIG. 6 has a circuit configuration similar to that of FIG. 3 and includes a control section 61 along with a motor drive circuit 62 for driving the motor 43, a motor drive circuit 63 for driving the conveyer motor 53 and a motor drive circuit 64 for driving the conveyer motor 54. The control section 61 controls a load controller 55 and receives the outcome of detection of the sensor 56 as input.

In the sheet processing apparatus 30 of FIG. 6, the rotary motion of the motor 43 is controlled by the motor drive circuit 62 of FIG. 3 and the rotary shaft 45 is driven to rotate so that the eccentric cams 42a, 42b are by turn driven to rotate.

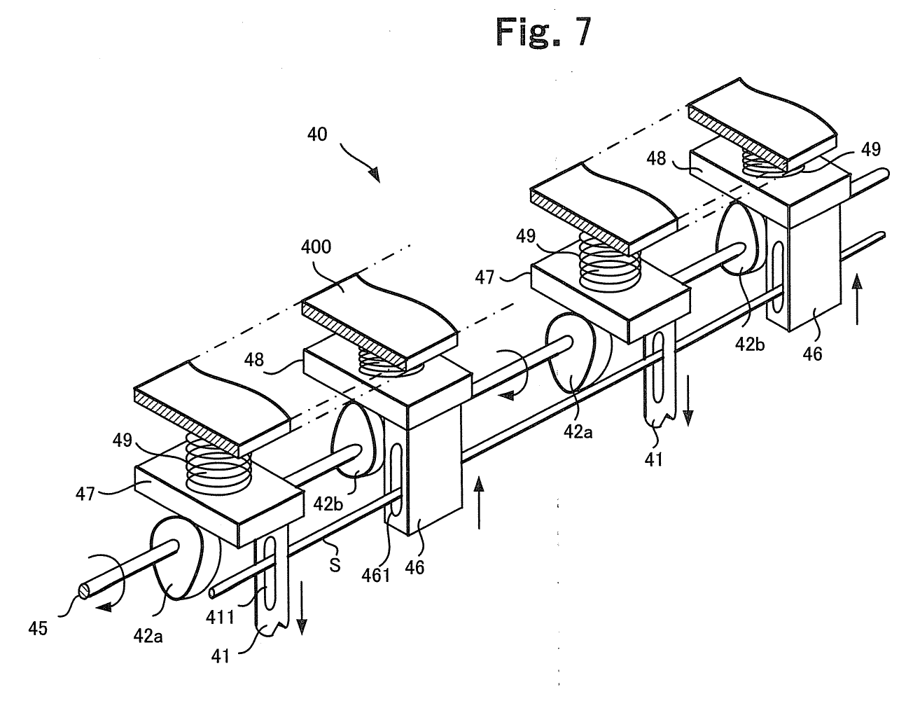

FIG. 7 is a schematic perspective view of the hole cutting blade 41 and the shutter 46 and their drive systems of the punch unit 40 of the sheet processing apparatus of FIG. 6, illustrating the specific configuration thereof.

Referring to FIG. 7, as a matter of fact, a pair of hole cutting blades 41 and a pair of shutters 46 are provided. The gap separating the pair of hole cutting blades 41 is equal to the gap separating a pair of holes punched through a sheet of paper P. The hole cutting blades 41 are fitted to respective support members 47. The shutters 46 are also fitted to respective support members 48.

On the other hand, two pairs of eccentric cams 42a, 42b are fitted to the rotary shaft 45 with a predetermined gap separating them to form a cam structure. The eccentric cams 42a are driven to rotate in order to move the support members 47 up and down respectively, whereas the eccentric cams 42b are driven to rotate in order to move the support members 48 up and down respectively. A frame 400 is arranged vis-à-vis the support members 47, 48 and springs 49 are arranged between the frame 400 and the support members 47, 48 to constantly urge the support members 47, 48 so as to be pushed against the eccentric cams 42a, 42b respectively.

The eccentric cams 42a, 42b are arranged in such a way that their front ends are angularly separated from each other by an angle of 180°. Therefore, the support members 47, 48 are driven to move up and down relative to each other as the rotary shaft 45 rotates. In other words, the hole cutting blades 41 and the shutters 46 are driven to move up and down in synchronism with the movements of the support members 47, 48 and the shutters 46 rise to their highest points when the hole cutting blades 41 fall to their lowest points, whereas the shutters 46 falls to their lowest points when the hole cutting blades 41 rise to their highest points. The support members 47, 48 and the cam structure concertedly form a reciprocating structure for reciprocating the hole cutting blades 41 and the shutters 46 in the direction of the sheet conveyance route.

The hole cutting blades 41 are provided respectively with vertically oblong holes 411, while the shutters 46 are also provided respectively with vertically oblong holes 461. A shaft S is made to run through the oblong holes 411, 461 as guide member and the opposite ends of the shaft S are rigidly secured in position. As a result, the hole cutting blades 41 and the shutters 46 are guided by the respective oblong holes 411, 461 and the shaft S so that they reciprocate accurately in the direction of the sheet conveyance route.

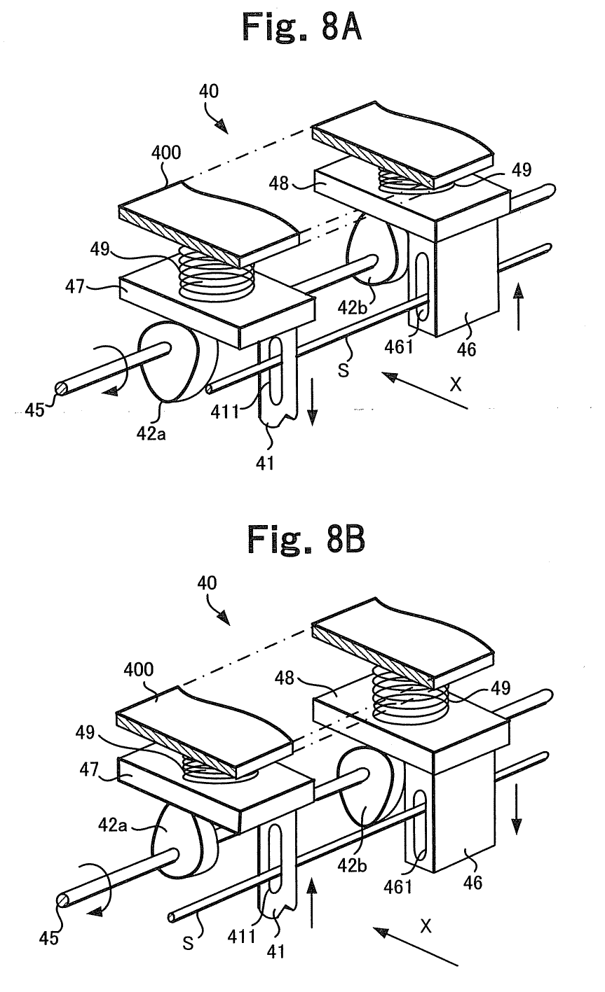

FIGS. 8A and 8B schematically illustrate the operation of the hole cutting blades 41 and the shutters 46. Both of the paired hole cutting blades 41 operate in the same way. Similarly, both of the paired shutters 46 operate in the same way. Therefore, only one of the hole cutting blades 41 and one of the shutters 46 are illustrated in FIGS. 8A and 8B.

FIG. 8A shows a condition where the hole cutting blade 41 is at the lowest position and the shutter 46 is at the highest position. In this condition, the front end of the eccentric cam 42a faces downward and the support member 47 is pressed downward by the spring 49. On the other hand, the front end of the eccentric cam 42b faces upward and the support member 48 is raised upward against the urging force of the spring 49.

FIG. 8B shows a condition where the hole cutting blade 41 is inversely at the highest position and the shutter 46 is at the lowest position. In this condition, the front end of the eccentric cam 42 faces upward and the support member 47 is raised upward against the urging force of the spring 49. On the other hand, the front end of the eccentric cam 42b faces downward and the support member 48 is pressed downward by the spring 49. Thus, as the rotary shaft 45 rotates, the hole cutting blade 41 and the shutter 46 reciprocate in a direction orthogonal relative to the direction of conveying a sheet of paper P.

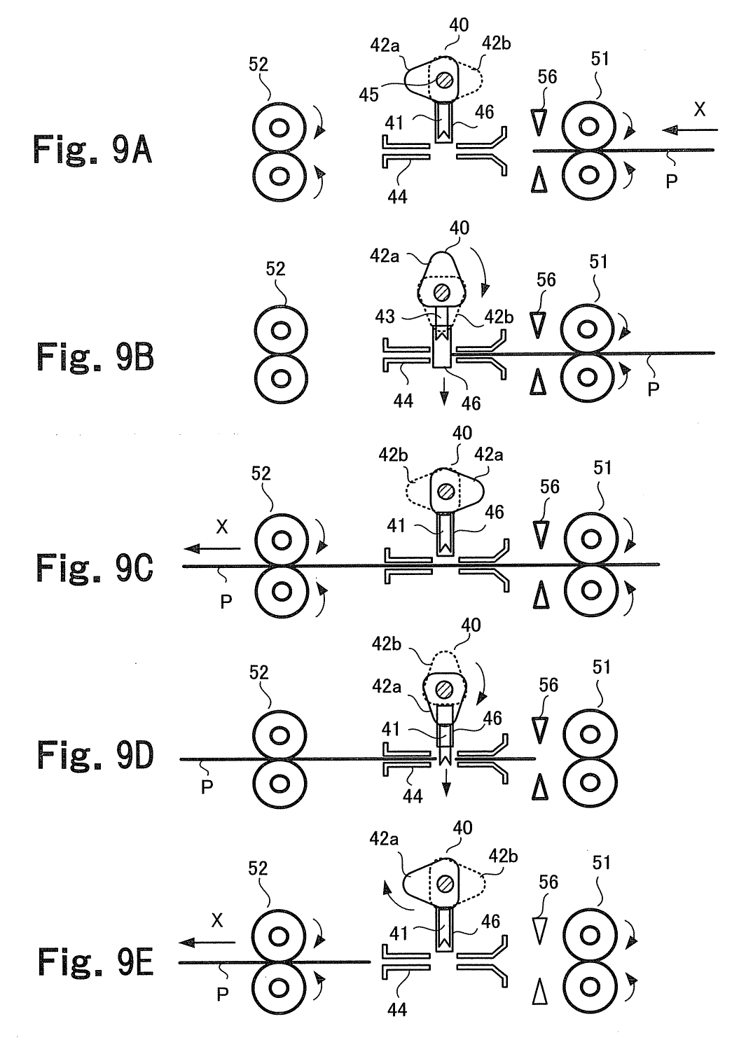

Now, the operation of the sheet processing apparatus 30 of FIG. 6 will be described below by referring to FIGS. 9A through 9E. Note that, in FIG. 9A through 9E, the support members 47, 48 are omitted and show only how the hole cutting blade 41 and the shutter 46 move in synchronism with the movements of the eccentric cams 42a, 42b.

FIG. 9A illustrates how a sheet of paper P is fed in by way of the image forming apparatus 10. In the initial stages, the first and second conveyer roller pairs 51 are driven to rotate respectively by the motors 53, 54 and the sheet of paper P is conveyed in the first direction (indicated by arrow X) from the upstream side toward the downstream side. Under this condition, the front ends of the eccentric cams 42a, 42b face sideways and the hole cutting blade 41 and the shutter 46 of the punching unit 40 are at the respective retracted positions located high above the punching die 44.

As the sheet of paper P is fed in and the sensor 56 detects that the leading end of the sheet of paper P passes the first conveyer roller pair 51, the motor 43 is driven to rotate to by turn drive the rotary shaft 45 to rotate. As a result, the front end of the eccentric cam 42a is made to face upward while the front end of the eccentric cam 42b is made to face downward as shown in FIG. 9B. The hole cutting blade 41 is moved to its highest position and the shutter 46 (stopper member) is lowered in the direction toward the punching die 44 to project and block the sheet of paper P being conveyed.

The first conveyer roller pair 51 is controlled by the load controller 55 in such a way that the paired rollers 511, 512 lightly contact with each other and operate as slipping roller. Therefore, the first conveyer roller pair 51 conveys the sheet of paper P with force weaker than before and makes the front end of the sheet of paper P abut the projecting shutter 46. In other words, the paired rollers 511, 512 press the sheet of paper P against shutter 46, while lightly contacting with each other so that the skew, if any, of the sheet of paper P is corrected.

Then, as shown in FIG. 9C, the motor 43 of the punching unit 40 is driven to operate to by turn drive the rotary shaft 45 to rotate while the sheet of paper P has been corrected for the skew, if any. As the rotary shaft 45 is driven to rotate, the front ends of the eccentric cams 42a, 42b are made to face sideways. The hole cutting blade 41 is lowered slightly from the highest position and the shutter 46 is raised slightly to an intermediate position. As a result, both the hole cutting blade 41 and the shutter 46 retreat from the sheet conveyance route. Additionally, the first conveyer roller pair 51 is controlled by the load controller 55 so as to operate as registration roller and driven to rotate by the motor 53 and convey the sheet of paper P that has been corrected for the skew, if any, in the direction of arrow X.

Then, as the sheet of paper P is conveyed by a predetermined distance and the sensor 56 detects that the tail end of the sheet of paper P passes the first conveyer roller pair 51 in the sheet conveying direction, the conveyer motor 54 stops its rotation and the second conveyer roller pair 52 also stops rotating as shown in FIG. 9D. As the second conveyer roller pair 52 stops rotating, the motor 43 of the punching unit 40 starts rotating to make the front end of the eccentric cam 42a face downward. Then, the hole cutting blade 41 falls to its lowest position to project across the sheet conveyance route to carry out a punching process on the sheet of paper P. At this time, the front end of the eccentric cam 42b also faces upward and the shutter 46 is at its highest position.

As the punching process is completed, the motor 43 starts rotating to make the eccentric cams 42a, 42b face sideways and the hole cutting blade 41 rises slightly from the lowest position while the shutter 46 falls slightly to get to an intermediate position as shown in FIG. 9E. Then, as a result, both the hole cutting blade 41 and the shutter 46 retreat from the sheet conveyance route. Then, the first and second conveyer roller pair 51, 52 are driven to rotate respectively by the conveyer rollers 53, 54 and the sheet of paper P is conveyed away.

Subsequently, the steps of operation of FIG. 9A through FIG. 9E are repeated so that sheets of paper P are sequentially subjected to a punching process one by one and delivered to the delivery tray 21 or 22.

The sensor 56 detects the leading end of the sheet of paper P when the sheet of paper P is fed in by way of the first conveyer roller pair 51. It also detects that the tail end of the sheet of paper P passes the position vis-à-vis the sensor 56 and notifies the control section 61 of what it detects. Then, the control section 61 controls the motor drive circuits 62, 63, 64 and the load controller 55 by referring to the outcome of detection of the sensor 56.

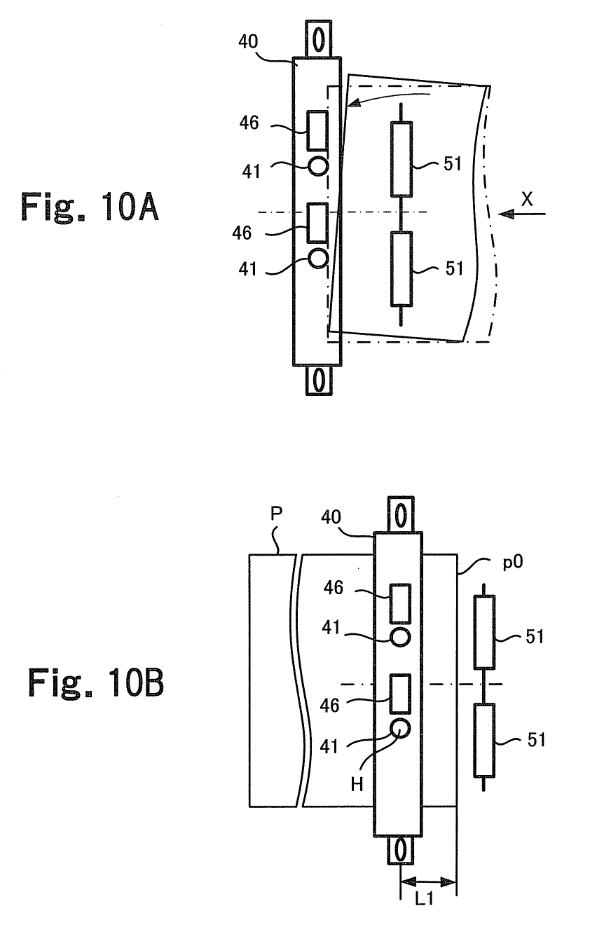

FIGS. 10A and 10B are schematic plan views of the second embodiment sheet processing apparatus according to the present invention, illustrating the skew correcting operation and the punching operation thereof. FIG. 10A shows a condition where a sheet of paper P passes the first conveyer roller pair 51 and abuts the shutter 46. In other words, this condition corresponds to that of FIG. 9B. At this time, the first conveyer roller pair 51 operates as slipping roller and hence, if the sheet of paper P is skewed as indicated by solid lines in FIG. 10A, the skew is corrected as indicated by dotted chain lines in FIG. 10A as the sheet of paper P is continuously and lightly pushed by the rotary motion of the first conveyer roller pair 51.

After the skew is corrected, the sheet of paper P is conveyed by the first conveyer roller pair 51 and the second conveyer roller pair 52 and, as the tail end pa of the sheet of paper P passes the first conveyer roller pair 51, the sensor 56 detects it to suspend the sheet conveying operation. Then, the hole cutting blade 41 carries out a punching process in a manner as shown in FIG. 10B so that a hole H is cut reliably at the right position on the sheet of paper P. Thus, this condition corresponds to that of FIG. 9D.

The hole cutting position of the punching process is defined typically by the predetermined distance L1 from the tail end p0 of the sheet of paper P as viewed in the sheet conveying direction (e.g., 12 mm). If the gap between the tail end p0 and the hole cutting position of the sheet of paper P is L1, the control section 61 performs its control operation in such a way that the conveyance of the sheet of paper is temporarily stopped at a position where the gap between the hole cutting blade 41 and the tail end p0 of the sheet of paper becomes equal to L1 to carry out a hole cutting operation before the tail end p0 of the sheet of paper passes the punching unit 40.

In this way, with the sheet processing apparatus 30 of the second embodiment according to the present invention, a sheet of paper P is conveyed from the upstream side to the downstream side and, when the sheet of paper P is fed in, the leading end of the sheet of paper P is made to abut the shutter 46 to correct the skew, if any. Since a punching process is executed by means of the hole cutting blade 41 on a sheet of paper whose skew, if any, has been corrected, the hole cutting operation is reliably carried out at the right position.

The finisher 20 is arranged contiguously relative to the image forming apparatus 10 and provided with the punching unit 40 in the instance of the above-described instance of FIG. 1. However, the punching unit 20 may alternatively be contained in the image forming apparatus 10. More specifically, the printer section 14 and the sheet processing section 30 may be arranged in a main body of the image forming apparatus 10 and the sheet of paper delivered from the printer section 14 may be subjected to a punching process by the punching unit 40 and corrected for the skew, if any.

Although exemplary embodiments of the present invention have been shown and described, it will be apparent to those having ordinary skill in the art that a number of changes, modifications or alternations to the invention as described herein may be made, none of which depart from the spirit of the present invention. All such changes, modifications and alterations should therefore be seen as within the scope of the present invention.

What is claimed is:

1. A sheet processing apparatus for executing a hole cutting process on a sheet of paper carrying an image formed thereon, the apparatus comprising:
a sheet conveying section including a first conveyer roller pair and a second conveyer roller pair arranged sequentially from the upstream side to the downstream side along a sheet conveyance route of the sheet of paper and adapted to convey a sheet of paper in a first direction directed from the upstream side to the downstream side;
a punching unit arranged between the first conveyer roller pair and the second conveyer roller pair and including a hole cutting blade for executing a hole cutting process on the sheet of paper, the punching unit being capable of retractably projecting a stopper member relative to the sheet conveyance route in order to temporarily stop the conveyance of the sheet of paper; and
a control section for controlling the operation of the punching unit by referring to the condition of conveying the sheet of paper;
the punching unit being adapted to cause the stopper member to project across the sheet conveyance route before the leading end of the sheet of paper being conveyed in the first direction gets to the punching unit so as to make the leading end of the sheet of paper abut the stopper member and correct the skew, if any, of the sheet of paper and to retreat from the sheet conveyance route after the correction of the skew and cause the hole cutting blade to project across the sheet conveyance route so as to execute a hole cutting process on the sheet of paper when the sheet of paper is conveyed downstream by a predetermined distance,
the stopper member of the punching unit is formed by using a shutter adapted to move back and forth relative to the hole cutting blade and the sheet conveyance route, and
the control section is adapted to control the punching unit so as to cause the shutter to project across and block the sheet conveyance route for correcting the skew, if any, but temporarily retreat and allow the sheet of paper to be conveyed toward the downstream side for executing the punching process and stops the conveyance of the sheet of paper before the tail end of the sheet of paper passes the punching unit to cause the hole cutting blade to project across the sheet conveyance route once again.

2. The apparatus according to claim 1 further comprising:
a detection means for detecting the position of the sheet of paper on the sheet conveyance route;
the control section is adapted to control the rotary condition of the first conveyer roller pair, that of the second conveyer roller pair, the back and forth movement of the shutter and that of the hole cutting blade of the punching unit according to the outcome of detection of the detection means.

3. The apparatus according to claim 2, wherein
the detection means is formed by using a sensor arranged close to the first conveyer roller pair at the downstream side; and
the control section is adapted to control the shutter so as to make it project across the sheet conveyance route when the sensor detects that the leading end of the sheet of paper is fed in by way of the first conveyer roller pair.

4. The apparatus according to claim 2, wherein
the detection means is formed by using a sensor arranged close to the first conveyer roller pair at the downstream side; and
the control section is adapted to control the hole cutting blade so as to make it project across the sheet conveyance route when the sensor detects that the sheet of paper that has been corrected for the skew, if any, is conveyed and that the tail end thereof passes the position of the sensor.

5. The apparatus according to claim 1, further comprising:
a cam structure having a rotary shaft to which a first eccentric cam and a second eccentric cam are fitted, the first eccentric cam and the second eccentric cam being adapted to rotate and operate in a symmetric manner; and
a back and forth movement mechanism including the hole cutting blade and the shutter and adapted to drive the hole cutting blade to move back and forth in the direction of the sheet conveyance route according to the rotation of the first eccentric cam and also the shatter to move back and forth in the direction of the sheet conveyance route according to the rotation of the second eccentric cam so as to relatively drive the hole cutting blade and the shutter.

6. The apparatus according to claim 5, wherein
the back and forth movement mechanism includes:
first and second support members arranged in parallel with the rotary shaft, the hole cutting blade being fitted to the first support member, the shutter being fitted to the second support member; and
spring members for urging the first and second support members so as to be pressed respectively against the first eccentric cam and the second eccentric cam.

7. The apparatus according to claim 5, wherein
the first and second support members have respective guide members to be used for moving back and forth in the direction of the sheet conveyance route.
